(19) United States
(12) Patent Application Publication
(10) Pub. No.: US 2009/0143586 A1
(43) Pub. Date: Jun. 4, 2009

(54) Method for producing alkyl-substituted aromatic and heteroaromatic compounds by cross-coupling alkyl boronic acids with aryl-or heteroaryl-halogenides or sulfonates under Pd catalysis in the presence of a ligand

(76) Inventors: Stefan Scherer, Griesheim (DE); Andreas Meudt, Hofheim (DE); Sven Nerdinger, Kiefersfelden (DE); Bernd Wilhelm Lehnemann, Frankfurt am Main (DE); Thomas Jagusch, Krefeld (DE); Victor Snieckus, Kingston (CA)

Correspondence Address: PROPAT, L.L.C., 425-C SOUTH SHARON AMITY ROAD, CHARLOTTE, NC, 28211-2841, US

(21) Appl. No.: 11/817,820

(22) PCT Filed: Mar. 7, 2006
(86) PCT No.: PCT/EP2006/002061

§ 371 Date: Sep. 5, 2007

(30) Foreign Application Priority Data
Mar. 16, 2005 (DE) 10 2005 012 005.9

(51) Int. Cl. C07F 5/02

(52) U.S. Cl. 546/13; 568/6

(57) ABSTRACT

The invention relates to a method for producing alkyl-substituted aromatic and heteroaromatic compounds by cross-coupling alkyl boronic acids with aryl- or heteroaryl-halogenides or with aryl- or heteroaryl-sulfonates in the presence of a catalyst and of a Brönsted base in a solvent or solvent mixture.

Method for producing alkyl-substituted aromatic and heteroaromatic compounds by cross-coupling alkylboronic acids with aryl or heteroaryl halides or aryl- or heteroarylsulfonates under Pd catalysis in the presence of a ligand

Alkyl-substituted aromatics and heteroaromatics, in particular with functional groups in the alkyl chain, are important and extremely versatile intermediates in organic synthesis. The significance in modern organic synthesis is restricted only by limitations of the availability of this compound class. A standard process for preparing alkyl-substituted aromatics and also heteroaromatics is Friedel-Crafts alkylation, but the reaction usually does not proceed regioselectively. Moreover, the reaction conditions, which are generally very severe, are rarely tolerated by functional groups and reactive heteroatoms and can only be employed on electron-deficient aromatics with great difficulty, if at all, and are difficult to control.

In modern organic synthesis, the significance of chemo-, regio- and stereoselective reagents is increasing explosively. When, for example, the intention is to introduce an alkyl group into a particular position in a substituted aromatic whose substituents direct electrophilic substitution differently, unselective methods such as Friedel-Crafts alkylation cannot be used.

It would therefore be very desirable to have a process which can convert alkylboronic acids and haloaromatics or haloheteroaromatics to the corresponding alkyl-substituted aromatics or heteroaromatics, at the same time achieves very high yields and can work with very small amounts of catalyst and can additionally be used in economically utilizable processes. The synthesis methods published to date for this purpose do not solve this problem and demonstrate many disadvantages, as will be demonstrated with reference to a few examples:
complicated or difficult ligand syntheses (e.g. M. Santelli et al., Tetrahedron 2004, 60, 3813-3818; Hartwig et al. J. Org. Chem. 2002, 67, 5533-5566)
use of large amounts of palladium up to 30 mol % (e.g. J. Med. Chem. 2001, 44, 3302-3310; Najera et al., J. Organomet. Chemistry 2002, 663, 46-57)
low yields (e.g. Wright et al., J. Org. Chem 1994, 59, 6095-6097; Percy et al, J. Chem. Soc., Perkin Trans./2000, 2591-2599)
without success in the case of substituted alkylboronic acids (e.g. Najera et al., J. Organomet. Chemistry 2002, 663, 46-57)
very low TONs (e.g. Bedford et al. Chem. Eur. J. 2003, 9, 3216-3227)
impracticable conditions, for example the use of microwaves (e.g. Kabalka et al., Synthesis 2003, 217-222)
high excess of expensive alkylboronic acids necessary (e.g. Bedford et al. Chem. Eur. J. 2003, 9, 3216-3227)

The present process solves these problems and relates to a process for preparing alkyl-substituted aromatics and heteroaromatics (III) by cross-coupling alkylboronic acids and derivatives thereof (II) with aryl halides or heteroaryl halides (I) with catalysis by transition metal compounds in the presence of readily obtainable or commercially available ligands and of a Bro/nsted base in a solvent, which achieves high yields with low catalyst loadings (equation 1)

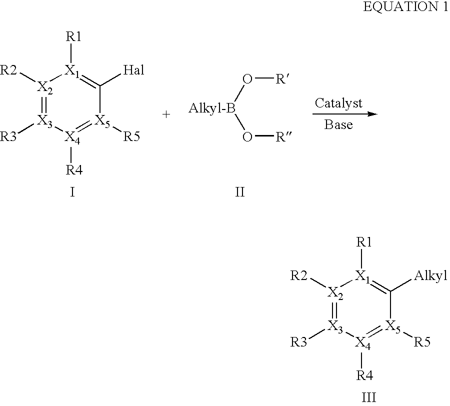

In this equation, Hal represents chlorine, bromine or iodine, or sulfonates, for example trifluoromethane-sulfonate (triflate), nonafluorotrimethylmethanesulfonate (nonaflate), methanesulfonate, benzenesulfonate, para-toluenesulfonate.

X₁₋₅ are each independently carbon or XᵢRᵢ are each nitrogen or in each case two adjacent XᵢRᵢ joined via a formal double bond together are O (furans), S (thiophenes), NH or NRᵢ (pyrroles).

Preferred compounds of the formula (III) which can be converted by the process according to the invention are, for example, benzenes, pyridines, pyrimidines, pyrazines, pyridazines, furans, thiophenes, pyrroles, any N-substituted pyrroles or naphthalenes, quinolines, indoles, benzofurans, etc.

The R₁₋₅ radicals are substituents from the group of {hydrogen, methyl, primary, secondary or tertiary, cyclic or acyclic alkyl radicals having from 2 to 20 carbon atoms, in which one or more hydrogen atoms are optionally replaced by fluorine or chlorine or bromine, e.g. CF₃, substituted cyclic or acyclic alkyl groups, hydroxyl, alkoxy, amino, alkylamino, dialkylamino, arylamino, diarylamino, alkylarylamino, phenyl, substituted phenyl, heteroaryl, substituted heteroaryl, thio, alkylthio, arylthio, diarylphosphino, dialkylphosphino, alkylarylphosphino, optionally substituted aminocarbonyl, CO₂^{—}, alkyl- or aryloxycarbonyl, hydroxyalkyl, alkoxyalkyl, fluorine or chlorine, nitro, cyano, aryl or alkyl sulfone, aryl- or alkylsulfonyl}, or in each case two adjacent R₁₋₅ radicals together may correspond to an aromatic, heteroaromatic or aliphatic fused-on ring.

Alkyl may be any linear, branched or cyclic alkyl radicals having from 1 to 40, preferably 1-20, especially 1-8 carbon atoms, in which one or more hydrogen atoms are optionally replaced by extraneous atoms or groups which are inert under the reaction conditions, for example fluorine, chlorine or bromine, hydroxyl, alkoxy, amino, alkylamino, dialkylamino, arylamino, diarylamino, alkylarylamino, phenyl, substituted phenyl, heteroaryl, substituted heteroaryl, thio, alkylthio, arylthio, diarylphosphino, dialkylphosphino, substituted aminocarbonyl, CO₂^{—}, alkyl- or aryloxycarbonyl, hydroxyalkyl, alkoxyalkyl, fluorine or chlorine, nitro, cyano, aryl or alkyl sulfone.

R′ and R″ may each independently be identical or different radicals from the group of {hydrogen, methyl, linear, branched C₁-C₂₀-alkyl or cyclic alkyl, optionally substituted phenyl} or together form a ring and stem from the group of {optionally substituted alkylene, branched alkylene, cyclic alkylene or optionally substituted azaalkylene}.

Typical examples of the compound II are thus methane-, ethane-, 1-methylethane-, propane-, 1-methylpropane-, 2-methylpropane-, 1,1-dimethylethane-, butane- and pentaneboronic acid, cyclopropane-, cyclobutane-, cyclopentane-, cyclohexaneboronic acid, etc., and also their methyl, ethyl, propyl, isopropyl, cyclohexyl esters, etc., and their ethylene glycol, pinacol and neopentyl glycol esters, etc., and their adducts with diethanolamine, N-methyl- or N-phenyldiethanolamine.

According to the invention, the catalyst used is a salt, a complex or an organometallic compound of a metal from the group of {Mn, Fe, Co, Ni, Cu, Rh, Pd, Ir, Pt}, preferably palladium or nickel. The catalyst may be added in finished form or be formed in situ, for example from a precatalyst by reduction or hydrolysis, or from a metal salt and added ligand by complex formation. The catalyst is used in combination with one or more phosphorus ligands. The metal may be used in any oxidation state. According to the invention, it is used in relation to the reactant I in amounts of from 0.001 mol % to 100 mol %, preferably between 0.01 and 10 mol %, more preferably between 0.01 and 1 mol %.

Preference is given to using, as catalysts, ligands of the structure

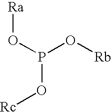

in conjunction with palladium or nickel. Ra, Rb and Rc are each independently a straight-chain, branched or cyclic alkyl radical or aryl radical which optionally bears substituents from the group of (straight-chain or branched alkyl, in particular methyl or isopropyl, cycloalkyl, aryl, fluorine, chlorine), or two of these radicals together may form a ring and stem from the group of {optionally substituted alkylene, optionally substituted ortho-arylene}, or three of these radicals may form a bicycle and stem from the group of {optionally substituted trialkylols}.

In a further preferred embodiment, a ligand of the structure

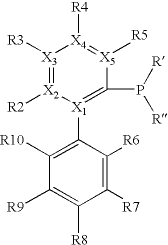

is used in conjunction with palladium or nickel as a catalyst.

In this structure,

X₁ is carbon or nitrogen, X₂₋₅ are each independently carbon or XᵢRᵢ is nitrogen or in each case two adjacent XᵢRᵢ where i=2, 3, 4, 5 joined via a formal double bond together are O (furans), S (thiophenes), NH or NRᵢ (pyrroles);
the R₂₋₁₀ radicals are substituents from the group of {hydrogen, methyl, primary, secondary or tertiary, acyclic or cyclic alkyl radicals having from 2 to 20 carbon atoms and in which one or more hydrogen atoms are optionally replaced by fluorine or chlorine or bromine, e.g. CF₃, substituted cyclic or acyclic alkyl groups, hydroxyl, alkoxy, amino, alkylamino, dialkylamino, arylamino, diarylamino, alkylarylamino, phenyl, substituted phenyl, heteroaryl, substituted heteroaryl, thio, alkylthio, arylthio, diarylphosphino, dialkylphosphino, alkylarylphosphino, optionally substituted aminocarbonyl, CO₂^{—}, alkyl- or aryloxycarbonyl, hydroxyalkyl, alkoxyalkyl, nitro, cyano, aryl or alkyl sulfone, aryl- or alkylsulfonyl} or in each case two adjacent R₁₋₅ radicals together are an aromatic, heteroaromatic or aliphatic fused-on ring;

R′ and R″ are each independently identical or different radicals from the group of {hydrogen, methyl, linear, branched or cyclic alkyl, optionally substituted, phenyl, optionally substituted} or together form a ring and are a bridging structural element from the group of {optionally substituted alkylene, branched alkylene, cyclic alkylene} or are each independently one or two polycyclic radicals, for example norbornyl or adamantyl.

In a further preferred embodiment, complexes of a secondary phosphine in conjunction with a palladacycle as a catalyst of the structure

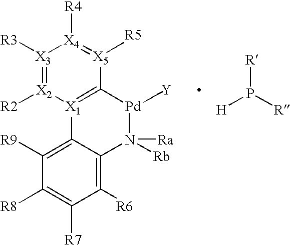

are used, where the symbols X₁₋₅, R₂₋₉, R′ and R″ are each as defined above and Y is a radical from the group of {halide, pseudohalide, alkyl carboxylate, trifluoroacetate, nitrate, nitrite} and
Rₐ and R_{b} are each independently identical or different substituents from the group of {hydrogen, methyl, primary, secondary or tertiary, optionally substituted alkyl or aryl} or together form a ring and stem from the group of {optionally substituted alkylene, oxaalkylene, thiaalkylene, azaalkylene}.

According to the invention, suitable catalysts or precatalysts are, for example, particular palladacycles and their phosphine complexes (e.g. IV (Solvias SK-CC01-A)) and complexes of palladium with biarylphosphines, some of which are very easily and economically obtainable (e.g. V and VI, for preparation see Regnat et al., EP 0 795 559) (FIGURE I). Particular emphasis should be given to the suitability of the very inexpensive trialkyl phosphites, e.g. triisopropyl phosphite VII, as ligands in conjunction with palladium or nickel salts.

Catalysts based on ferrocenylphosphine-transition metal complexes or sterically hindered trialkylphosphine-transition metal complexes often likewise achieve full conversions of the starting materials.

The addition of Bro/nsted bases to the reaction mixture is necessary in order to achieve acceptable reaction rates. Very suitable bases are hydroxides, amines and alkoxides and fluorides of the alkali metals and alkaline earth metals, carbonates, hydrogencarbonates and phosphates of the alkali metals and mixtures thereof. Particularly suitable bases are those from the group of {sodium hydroxide, potassium hydroxide, sodium carbonate, potassium carbonate, cesium carbonate, sodium bicarbonate, potassium bicarbonate, cesium bicarbonate, potassium phosphate}. Typically at least the amount of base which corresponds to the amount of the boronic acid II is used; usually 1.0 and 6 equivalents, preferably from 2 to 5 equivalents, of base are used, based on the boronic acid II.

The reaction is performed in a suitable solvent or mono- or polyphasic solvent mixture which has a sufficient dissolution capacity for all reactants involved. Very suitable solvents are open-chain and cyclic ethers and diethers, mono- or polyhydric alcohols, optionally substituted aromatics, water, optionally substituted amides, dimethyl sulfoxide, N-methylpyrrolidone and optionally substituted ureas, and also esters. Particular preference is given to using one solvent or mixtures of a plurality of solvents from the group of {water, tetrahydrofuran, 1,4-dioxane, methanol, ethanol, isopropanol, propanol, butanol, ethylene glycol, toluene, xylene, dimethylformamide, dimethylacetamide}.

The reaction can be performed at temperatures between room temperature and the boiling point of the solvent used at the pressure used. In order to achieve a more rapid reaction, performance at elevated temperatures in the range of 20 and 240° C. is preferred. Particular preference is given to the temperature range from 60 to 150° C.

The concentration of the reactants can be varied within wide ranges. Appropriately, the reaction is performed in a possibly high concentration, in which case the solubilities of the reactants and reagents in the particular reaction medium have to be noted. Preference is given to performing the reaction within the range between 0.05 and 5 mol/l based on the reactants present in deficiency.

Boronic acid (II) and aromatic or heteroaromatic reactant (I) may be used in molar ratios of from 10:1 to 1:10, preference being given to ratios of from 3:1 to 1:3 and particular preference to ratios of from 1.2:1 to 1:1.2.

In one of the preferred embodiments, all materials are initially charged and the mixture is heated to reaction temperature with stirring. In a further preferred embodiment, which is suitable particularly for employment on a large scale, the boronic acid and any further reactants are metered in to the reaction mixture during the reaction.

The workup is effected typically under aqueous conditions with removal of the aqueous phase which takes up the inorganic constituents and any excess boronic acid, while the product remains in the organic phase unless acidic functional groups present lead to a different phase behavior. Optionally, ionic liquids can be used to remove the relatively polar constituents. The product is preferably isolated from the organic phase by precipitation, for example by concentration or by addition of precipitants. Frequently, additional purification, for example by recrystallization or chromatography, is unnecessary. The isolated yields are usually in the range from 75 to 100%, preferably in the range from >85% to 100%, especially from >92% to 100%.

The process according to the invention opens up a very economical method of preparing alkylaromatics and alkylheteroaromatics proceeding from the corresponding alkylboronic acids or derivatives thereof and the corresponding aryl or heteroaryl halides or aryl- or heteroarylsulfonates. In this way, substrates for which “common” Suzuki couplings fail are also obtainable for the first time, because both the aryl and the alkyl radical contain functional groups which are not stable toward Grignard or organolithium intermediates (Example 5).

The process according to the invention will be illustrated by the examples which follow without the invention being restricted thereto:

Example 1:

Suzuki coupling of bromobenzene with n-butylboronic acid with catalysis by 2′-(dimethylamino)-2-biphenylylpalladium(II) chloride-dinorbornylphosphine complex (SK-CC01-A)

With exclusion of air, 0.157 g of bromobenzene (1.0 mmol), 0.152 g of butylboronic acid (1.5 mmol), 5.6 mg of SK-CC01-A (0.01 mmol, 1 mol %) and 1 ml of 3N sodium hydroxide solution (3 mmol) in 5 ml of dioxane were heated to 105° C. with stirring until the conversion (according to GC) was complete. The mixture was allowed to cool, the reaction mixture was extracted with 4 ml of water and the organic phase was removed. Filtration through silica gel (eluent: ethyl acetate) afforded 0.125 g (0.93 mmol, 93%) of n-butylbenzene.

Example 2: as Example 1, except that 637 mg (3 mmol) of anhydrous potassium phosphate were used in place of the sodium hydroxide solution. Instead of dioxane, the solvent used was 5 ml of a mixture of dimethylacetamide, toluene and tetrahydrofuran (1:1:1). The yield was 94%.

Example 3: as Example 1, except that 318 mg of sodium carbonate (3 mmol) and 33 mg of cesium carbonate (0.3 mmol) were used in place of the sodium hydroxide solution. The solvent used was 5 ml of toluene. The yield was 96 %.

Example 4: as Example 1, except that the dioxane solvent was replaced by 5 ml of a mixture of toluene and isopropanol (1:1). 94% butylbenzene was obtained.

Example5:

Suzuki coupling of ethyl 4-chlorobenzoate with 2-(ethoxycarbonyl)ethylboronic acid with catalysis by dicyclohexyl-(61-methoxybiphenyl-2-yl)phosphine-palladium complex

With exclusion of air, 0.185 g of ethyl 4-chlorobenzoate (1.0 mmol), 0.175 g of 2-(ethoxycarbonyl)ethylboronic acid (1.2 mmol), 38 mg of dicyclohexyl-(6′-methoxybiphenyl-2-yl)phosphine (0.1 mmol, 10 mol %), 11 mg of palladium(II) acetate (0.05 mmol, 5 mol %) and 1 ml of 3N sodium hydroxide solution (3 mmol) in 5 ml of isopropanol were heated to 105° C. with stirring until the conversion (according to GC) was complete. The mixture was allowed to cool, the reaction mixture was extracted with 4 ml of water and the organic phase was removed. Filtration through silica gel (eluent: ethyl acetate) afforded 0.225 g (0.90 mmol, 90%).

Example 6: as Example 5, except that the base used was 637 mg (3 mmol) of anhydrous potassium phosphate instead of sodium hydroxide solution and the solvent used was a 1:1:1 mixture of tetrahydrofuran/isopropanol/toluene. The yield was 88%.

Example 7: as Example 5, except that 318 mg of sodium carbonate (3 mmol) and 33 mg of cesium carbonate (0.3 mmol) were used in place of the sodium hydroxide solution. The solvent used was 5 ml of toluene. The yield was 92%.

Example 8:

Suzuki coupling of 3-bromopyridine with 3,3-(diethoxy)propaneboronic acid with catalysis by dicyclohexyl-(6′,2′-dimethoxybiphenyl-2-yl)phosphine-palladium complex

With exclusion of air, 0.158 g of 3-bromopyridine (1.0 mmol), 0.211 g of 3,3-(diethoxy)propaneboronic acid (1.2 mmol), 41 mg of dicyclohexyl-(6′,2′-dimethoxybiphenyl-2-yl)phosphine (0.1 mmol, 10 mol %), 11 mg of palladium(II) acetate (0.05 mmol, 5 mol %) and 637 mg (3 mmol) of anhydrous potassium phosphate in 5 ml of a 1:1:1 dioxane/tetrahydrofuran/toluene mixture were heated to 105° C. with stirring until the conversion (according to GC) was complete. The mixture was allowed to cool, the reaction mixture was extracted with 8 ml of 2N NaOH and the organic phase was removed. Filtration through silica gel (eluent: ethyl acetate with 1% triethylamine) afforded 0.195 g (0.93 mmol, 93%) of 3-(3-pyridyl)propionaldehyde diethyl acetal.

Example 9: as Example 8, except that 318 mg of sodium carbonate (3 mmol) and 33 mg of cesium carbonate (0.3 mmol) were used in place of the potassium phosphate. The solvent used was 5 ml of dioxane. The yield was 87%.

Example 10: as Example 8, except that the base used was 1 ml of 3N aq. NaOH (3 mmol) in place of potassium phosphate. The solvent used was 5 ml of isopropanol. 84% yield was obtained.

Example 11: as Example 8, except that the solvent used was 5 ml of a mixture of tetrahydrofuran with water in a ratio of 9:1. The yield was 88%.

Example 12: as Example 8, except that the base used was 1 ml of 3N sodium hydroxide solution (3 mmol) and the solvent used was 5 ml of a mixture of tetrahydrofuran/water/toluene in a ratio of 19:1:20. In this case, 76% product was isolated.

Example 13: as Example 12, except that the base used was 318 mg of sodium carbonate (3 mmol) and 33 mg of cesium carbonate (0.3 mmol). 84% yield was obtained.

Example 14:

Suzuki coupling of 4-bromobenzotrifluoride with butaneboronic acid with catalysis by triisopropyl phosphite-palladium complex

With exclusion of air, 0.225 g of 4-bromobenzotrifluoride (1.0 mmol), 0.122 g of butaneboronic acid (1.2 mmol), 21 mg of triisopropyl phosphite (0.1 mmol, 10 mol %), 11 mg of palladium(II) acetate (0.05 mmol, 5 mol %) and 1 ml of 3N sodium hydroxide solution (3 mmol) in 5 ml of a 19:1:20 tetrahydrofuran/water/isopropanol mixture were heated to 105° C. with stirring until the conversion (according to GC) was complete. The mixture was allowed to cool, the reaction mixture was extracted with 4 ml of 2N NaOH and the organic phase was removed. Filtration through silica gel (eluent: ethyl acetate) afforded 0.186 g (0.92 mmol, 92%) of 4-butyltrifluoromethylbenzene.

Example 15: as Example 14, except that the base used was 637 mg (3 mmol) of anhydrous potassium phosphate in place of sodium hydroxide solution and the solvent used was dioxane. The yield was 92%.

Example 16: as Example 15, except that 6.5 mg (0.05 mmol) of anhydrous nickel(II) chloride were used instead of palladium acetate. 86% product was obtained.

1. A process for preparing alkyl-substituted aromatics and heteroaromatics (III) comprising cross-coupling alkylboronic acids (II) with aryl or heteroaryl halides or aryl- or heteroarylsulfonates (I) in the presence of a catalyst and of a Bro/nsted base, in a solvent or solvent mixture, 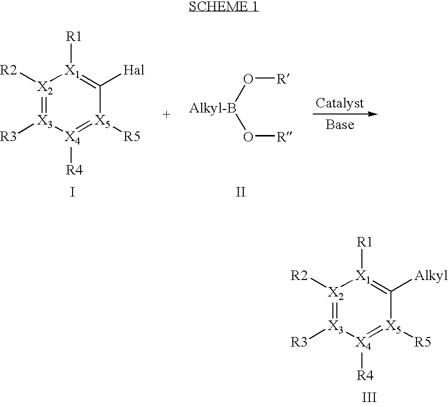
wherein
Hal is chlorine, bromine, iodine, trifluoromethanesulfonate, nonafluorotrimethylmethane-sulfonate, methanesulfonate, 4-toluenesulfonate, benzenesulfonate, 2-naphthalenesulfonate, 3-nitrobenzenesulfonate, 4-nitrobenzenesulfonate, 4-chlorobenzenesulfonate or 2,4,6-triisopropylbenzenesulfonate,
X₁₋₅ are each independently carbon,
X₁Rᵢ is nitrogen, or in each case two adjacent XᵢRᵢ joined via a formal double bond together are O (furan), S (thiophenes), NH or NRᵢ (pyrroles),
the radicals
R₁₋₅ are substituents from the group of
hydrogen, methyl, primary, secondary or tertiary, cyclic or acyclic alkyl radicals having from 2 to 20 carbon atoms, in which one or more hydrogen atoms are optionally replaced by fluorine or chlorine or bromine, substituted cyclic or acyclic alkyl groups, hydroxyl, alkoxy, amino, alkylamino, dialkylamino, arylamino, diarylamino, alkylarylamino, phenyl, substituted phenyl, heteroaryl, substituted heteroaryl, thio, alkylthio, arylthio, diarylphosphino, dialkylphosphino, alkylarylphosphino, optionally substituted aminocarbonyl, CO₂^{—}, alkyl- or aryloxycarbonyl, hydroxyalkyl, alkoxyalkyl, fluorine or chlorine, nitro, cyano, aryl or alkyl sulfone, aryl- or alkylsulfonyl,
or in each case two adjacent radicals R₁₋₅
together are an aromatic, heteroaromatic or aliphatic fused-on ring, alkyl is any linear, branched or cyclic alkyl radicals having from 1 to 40 carbon atoms, in which one or more hydrogen atoms are optionally substituted by atoms or functions from the group of fluorine, optionally chlorine or bromine, hydroxyl, alkoxy, amino, alkylamino, dialkylamino, arylamino, diarylamino, alkylarylamino, phenyl, substituted phenyl, heteroaryl, substituted heteroaryl, thio, alkylthin, arylthio, diarylphosphino, dialkylphosphino, alkylarylphosphino, optionally substituted aminocarbonyl, CO₂^{—}, alkyl- or aryloxycarbonyl, hydroxyalkyl, alkoxyalkyl, fluorine or chlorine, nitro, cyano, aryl or alkyl sulfone,
R′ and R″ are each independently identical or different radicals from the group of hydrogen, methyl, linear, branched or cyclic alkyl, optionally substituted, phenyl, optionally substituted or together form a ring and represent a bridging structural element from the group of optionally substituted alkylene, branched alkylene, cyclic alkylene or optionally substituted azaalkylene,
the catalyst being used in combination with one or more phosphorus ligands and the phosphorus ligand being either
a ligand of the structure 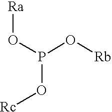
in conjunction with palladium or nickel as a catalyst,
where
Ra, Rb and Rc are each independently a straight-chain, branched or cyclic alkyl radical or aryl radical which optionally bears substituents from the group of straight-chain or branched alkyl, cycloalkyl, aryl, fluorine, chlorine, or two of these radicals together may form a ring and stem from the group of optionally substituted alkylene, optionally substituted ortho-arylene,
or three of these radicals may form a bicycle and stem from the group of optionally substituted trialkylols
or
a ligand of the structure 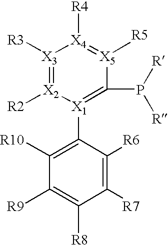
in conjunction with palladium or nickel as a catalyst, where
Xᵢ is carbon or nitrogen,
X₂₋₅ are each independently carbon,
XᵢRᵢ is nitrogen or in each case two adjacent XᵢRᵢ where i=2, 3, 4, 5 joined via a formal double bond together are O (furans), S (thiophenes), NH or NRᵢ (pyrroles),
the R₂₋₁₀ radicals are substituents from the group of
hydrogen, methyl, primary, secondary or tertiary, acyclic or cyclic alkyl radicals having from 2 to 20 carbon atoms and in which one or more hydrogen atoms are optionally replaced by fluorine or chlorine or bromine, substituted cyclic or acyclic alkyl groups, hydroxyl, alkoxy, amino, alkylamino, dialkylamino, arylamino, diarylamino, alkylarylamino, phenyl, substituted phenyl, heteroaryl, substituted heteroaryl, thio, alkylthio, arylthio, diarylphosphino, dialkylphosphino, alkylarylphosphino, optionally substituted aminocarbonyl, CO₂³¹ , alkyl- or aryloxycarbonyl, hydroxyalkyl, alkoxyalkyl, nitro, cyano, aryl or alkyl sulfone, aryl- or alkylsulfonyl
or in each case two adjacent radicals
R₁₋₅ together are an aromatic, heteroaromatic or aliphatic fused-on ring,
R′ and R″ are each independently identical or different radicals from the group of hydrogen, methyl, linear, branched or cyclic alkyl, phenyl or together form a ring and are a bridging structural element from the group of alkylene, branched alkylene, cyclic alkylene or are each independently one or two polycyclic radicals, for example norbornyl or adamantyl,
or
a complex of a secondary phosphine in conjunction with a palladacycle as a catalyst of the structure 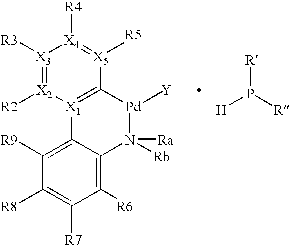
where the symbols
X₁₋₅, R₂₋₉, R′ and R″ are each as defined above and
Y is a radical from the group of
halide, pseudohalide, alkyl carboxylate, trifluoroacetate, nitrate, nitrite and
Rₐ and R_{b} are each independently identical or different substituents from the group of hydrogen, methyl, primary, secondary or tertiary, optionally substituted alkyl or aryl
or together form a ring and stem from the group of optionally substituted alkylene, oxaalkylene, thiaalkylene, azaalkylene.

2. The process as claimed in claim 1, wherein the Bro/nsted base used is a hydroxide, amine, alkoxide or fluoride of the alkali metals or alkaline earth metals, or an alkali metal carbonate, hydrogencarbonate, phosphate or monohydrogenphosphate or mixtures thereof.

3. The process as claimed in claim 2, wherein from 1.0 to 5 equivalents of base based on the boronic acid are used.

4. The process as claimed in claim 1, wherein the solvents used are water, aliphatic alcohols, aliphatic glycols, aliphatic and/or aromatic ethers, substituted aromatics, aliphatic amides, ureas, sulfoxides, N-methylpyrrolidone or a mixture of a plurality thereof.

5. The process as claimed in claim 1, wherein the cross-coupling is performed at a temperature in the range from 20 to 240° C.

6. The process as claimed in claim 1, wherein the catalyst is used in amounts of from 0.001 mol % to 100 mol % in relation to the aryl or heteroaryl halides or aryl- or heteroarylsulfonates (I).
